(19) United States
(12) Patent Application Publication
(10) Pub. No.: US 2003/0093806 A1
(43) Pub. Date: May 15, 2003

(54) Remote re-creation of data in a television system

(76) Inventors: Vincent Dureau, Palo Alto, CA (US); Patty Kim, Milpitas, CA (US); Michael Collette, Redwood Shores, CA (US)

Correspondence Address: Rory D. Rankin, Conley, Rose, & Tayon, P.C., P.O. Box 398, Austin, TX, 78767, US

(21) Appl. No.: 09/991,083

(22) Filed: Nov. 14, 2001

(51) Int. Cl. H04N 7/173

(52) U.S. Cl. 725/107; 725/115; 725/116

(57) ABSTRACT

A method and mechanism for recreating particular data at a remote location within a television system. While watching television, a viewer tags a particular television program which is deemed of interest. The viewer then generates a message including an edit list which identifies the tagged program material and conveys the message to a remote location. The message is received at the remote location by a receiving device. The receiving device is configured to then capture and record the identified program material in response to processing the message. Capture of the identified program material may begin immediately, or may be scheduled for a later time. The receiving device is configured to either determine when the identified program material will next be broadcast, or may be configured to generate a request for the program material from a remote content server. The message may identify a single program, or multiple program selections taken from one or more programs. Also, a television operator may generate different edit lists targeted to different groups within a viewing audience. The edit lists may correspond to profiles based on audience data gathered by the operator. These edit lists are then conveyed to members of the viewing audience. The operator then conveys a broadcast signal including a variety of program material. Audience member's receiving devices then capture particular portions of the broadcast signal based on the prior received edit lists.

### BACKGROUND OF THE INVENTION

1. Field of the Invention

The present invention relates generally to television systems and, more particularly, to the use of targeted messages to facilitate recording of selected content.

2. Description of Related Art

Television service providers, such as a satellite broadcaster or a cable multiple system operator (MSO), transmit audio-video streams to a viewer's television system. The viewer's television system frequently consists of a set-top box connected to a television set and a recording device, but may consist of any number of suitable devices. In addition to the audio and video that viewers typically think of as television programs, television service providers may transmit additional information as well. For example, the additional information may be instructions which are interpreted by an interpreter or virtual machine. Alternatively, a service provider may transmit HTML data for rendering by a presentation engine. If the broadcast is analog, this additional information may be encoded in the VBI (vertical blanking interval). If the broadcast is digital, additional information may be multiplexed with the audio and video according to a standard format, such as MPEG-2, or a proprietary format.

Interactive television systems provide a means to deliver interactive content as well as ordinary television audio and video to a large number of subscribers. Programs broadcast by these systems may incorporate television audio and video, still images, text, interactive graphics and applications, and many other components. The interactive content of the interactive television signal may therefore include application code, data associated with the audio and video, control signals, raw data and many other types of information. Both the interactive content and the audio and video data may be delivered to subscribers as “pushed” data. That is, the data is delivered to each of the subscribers, regardless of whether or not the subscribers requested the data.

The interactive functionality of the television is generally controlled by a receiving device, such as an Integrated Receiver Decoder (IRD), which may, for example, be embodied in a television, set-top box, or other device connected to the television. The IRD receives the signal transmitted by a broadcast service provider or system operator, separates the interactive portion, if present, from the audio-video portion and decompresses the respective portions of the signal. The IRD uses the interactive information to, for example, execute an application while the audio-video information is transmitted to the television. The IRD may combine the audio-video information with interactive graphics or audio generated by the interactive application prior to transmitting the information to the television. The interactive graphics and audio may present additional information to the viewer or may prompt the viewer for input. The IRD may provide viewer input or other information to the broadcast service provider or system operator via a return path. In addition to receiving pushed content, some components may be pulled from a server as well.

Interactive content such as application code or information relating to television programs is sometimes broadcast in a repeating format. In other words, each piece of information is broadcast a first time, then each is transmitted a second time, and so on. The cycle is repeated so that each piece of interactive data is transmitted, for example, every ten seconds. The pieces of information which are broadcast in this manner form what can be referred to as a “carousel.” Frequently, a single carousel is transported as a contiguous data stream. However, it is also possible to multiplex two or more carousels in a single data stream. Instead of using a carousel format, some interactive television systems may be configured to more heavily use a return path, requiring the IRD to request much of the interactive content via the return path.

Broadcast systems (e.g., interactive television systems) transmit information in a carousel format in order to allow receivers in the system to selectively obtain particular pieces of information in the carousel without requiring a return path from the receivers to the server. If a particular receiver needs a particular piece of information, it can simply wait until the next time that piece of information is broadcast, and then extract the information from the broadcast data stream. Other receivers in the system can operate in the same manner, each receiver waiting for the information it needs, and then using only that information. By employing carousels to broadcast information, the system eliminates the need to connect each of the receivers with the server and further eliminates the need for the server to process individual requests for information. Generally, a broadcast signal may include a number of programs which in turn may include a number of audio/video streams and/or data streams. Data streams may be used to carry data such as interactive application data, subtitle information, or other data. In addition to the above, some receivers may be configured to cache received data for use at a future time.

The pieces of information, or data objects, in a carousel may be intended to be combined in a single object data stream to form a program. This program may also contain streaming data such as audio or video. For example, an interactive television game show may combine television audio and video with interactive content such as application code which allows users to answer questions. Another example would be a news program which combines audio and video with application code that inserts current stock prices in a banner at the bottom of the screen. (It should be noted that many types of programs are possible, and it is not necessary to include either audio, video or interactive content with any particular program. A program might contain only audio and interactive data (e.g., an interactive radio program,) or it might contain only interactive data (e.g., an interactive weather program that does not contain audio or video streams.) Typically, each program is associated with a corresponding channel and, when a channel containing a particular program is selected by the interactive television receiver, the data which is being broadcast on that channel is downloaded and the program is started. Alternatively, a separate stream may be used for the transmission of one or more carousels of content. For example, a separate stream may transmit content intended to provide interactive enhancement of multiple channels.

One activity which is common for television viewers is the recording of programs which are of particular interest. In some cases, believing a program will be of particular interest to a friend or some other person, a viewer may give a recorded copy of the program to the friend for viewing. Frequently, however, the viewer may forget to give the friend the copy, may not see the friend, may no longer have the recorded copy, or otherwise. For any of a variety of reasons, the desired program may never be conveyed to the friend. Alternatively, the viewer may call the friend by telephone to let them know about the program. In response, the friend could begin recording the program or program their recording device to record the program at a later time. However, if the friend is not home, or is otherwise unavailable, the program may be missed.

What is desired is a method and mechanism for facilitating the recording of program and other material by a remote recording device.

### SUMMARY OF THE INVENTION

A method and mechanism are contemplated for recreating particular data at a remote location within a television system. In one embodiment, a television viewer tags a particular television program, or portion of a program, which is deemed of interest. The viewer then generates a message including an edit list which identifies the tagged program material and conveys the message to one or more persons at a remote location(s). The message is received at the remote location by a receiving device. The receiving device is configured to then capture the identified program material in response to processing the message. Capture of the identified program material may begin immediately, or may be scheduled for a later time. The receiving device is configured to either determine when the identified program material will next be broadcast and schedule capture for that time, may be configured to generate a request for the program material from a remote content server, or may monitor the broadcast until a signal is sent that the program material is being transmitted. The edit list may identify a single program, or multiple program selections taken from one or more programs.

Also contemplated is a system in which a television operator may generate different edit lists target to different groups within a viewing audience. In one embodiment, the edit lists correspond to profiles based on audience data gathered by the operator. These edit lists are then conveyed by the operator to members of the viewing audience. The operator further conveys a broadcast signal including a variety of program material. Audience member's receiving devices then capture particular portions of the broadcast signal based on the particular edit list which they have received. Alternatively, the operator may generate a number of different edit lists identifying different program materials. These edit lists may then be made available to audience members who may then access them. The accessed edit lists may then be utilized by a receiving device at the viewer's location to generate a virtual channel of customized programming.

### BRIEF DESCRIPTION OF THE DRAWINGS

Other objects and advantages of the invention will become apparent upon reading the following detailed description and upon reference to the accompanying drawings in which:

FIG. 1 is a diagram of one embodiment of a broadcast television system.

FIG. 2 is a diagram of one embodiment of a headend.

FIG. 3 illustrates one embodiment of a basic message system.

FIG. 4 is a block diagram of one embodiment of a client device.

FIG. 5 illustrates one embodiment of message generation.

FIG. 6 is a diagram of one embodiment of a peer-to-peer system.

FIG. 7 illustrates one embodiment of a system including a content server.

FIG. 8 illustrates one embodiment of control lists.

FIG. 9 is a diagram of one embodiment of method of tagging.

FIG. 10 is a diagram of one embodiment of method of tagging.

FIG. 11 is a diagram of one embodiment of method of tagging.

FIG. 12 is a diagram of one embodiment of method of tagging.

FIG. 13 is a diagram of one embodiment of method of tagging.

FIG. 14 illustrates one embodiment of an edit list type message.

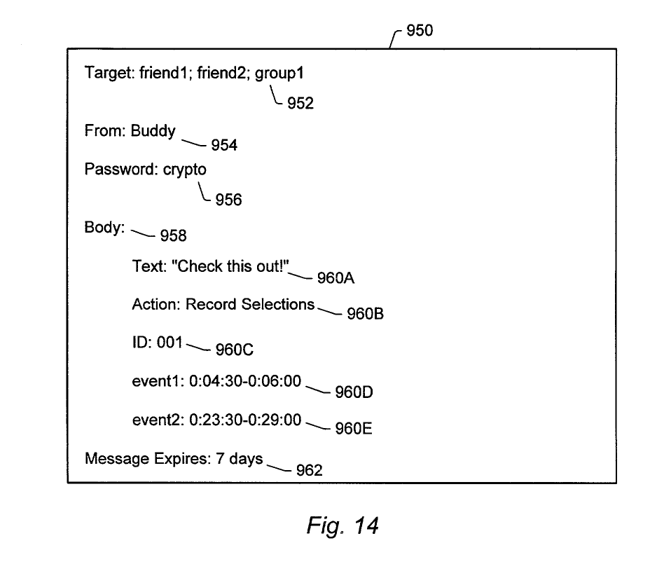

FIG. 15 is a diagram of one embodiment of an operator based embodiment.

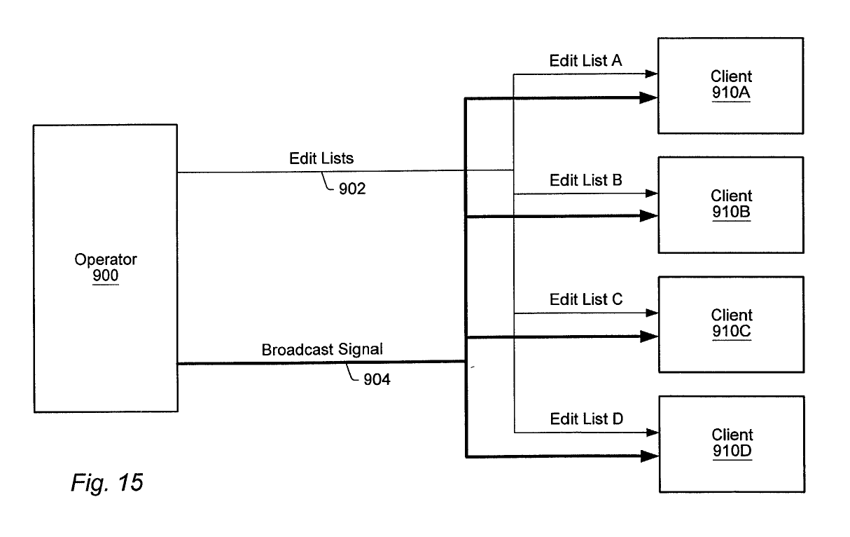

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

System Overview

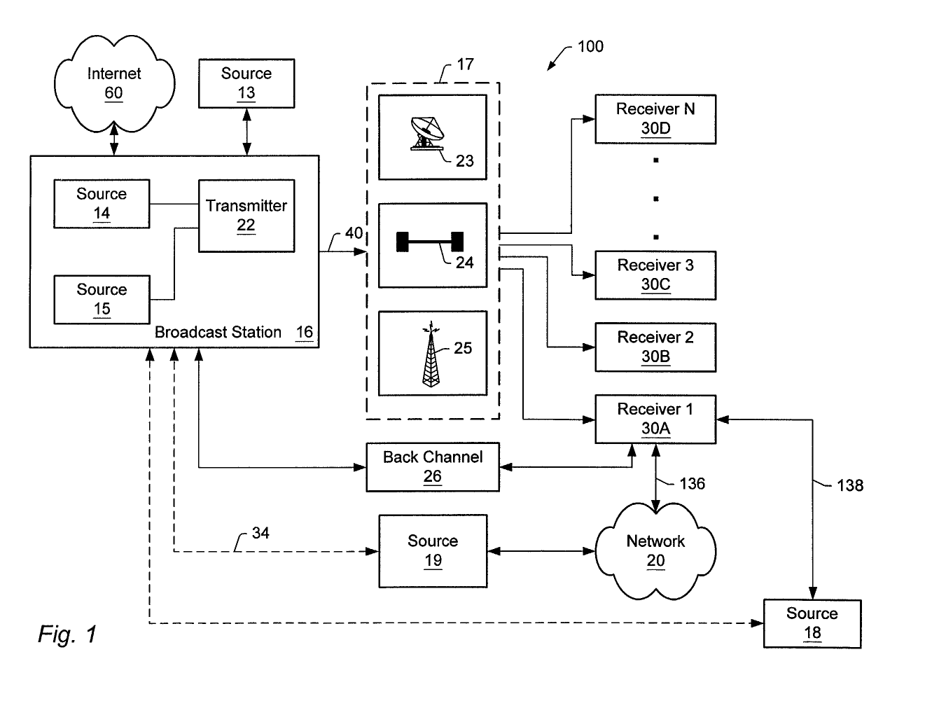

Referring to FIG. 1, one embodiment of a television system 100 is shown. In the embodiment shown, receiving devices 30 are coupled to several sources of programming and/or interactive content. Receiving devices 30 may comprise any number of suitable devices, examples of such devices include a set-top box (STB), a television (TV), a video cassette recorder (VCR), a personal video recorder (PVR), a personal digital assistant (PDA), a personal computer (PC), a video game console, or a mobile/cell phone.

Included in the embodiment of FIG. 1 is a broadcast station 16 coupled to receiver(s) 30 via a transmission medium 17 and back channel 26. In addition, receiver(s) 30 are coupled to a source 18 and source 19 via a network 20. Further, broadcast station 16 is coupled to a remote source 13, and Internet 60. In the embodiment shown, broadcast station 16 includes sources 14 and 15 and transmitter 22. Transmission medium 17 may comprise a satellite based system 23, a cable based system 24, a terrestrial or multiple multi-point distribution service (MMDS) based system 25, a combination of these systems, or some other suitable system of transmission.

In the embodiment of FIG. 1, broadcast station 16 may include a variety of sources of content 14, 15, and 60 to be utilized and conveyed by transmitter 22. Content sources 14 and 15 may include databases, application servers, other audio/video sources, or other data sources. In one embodiment, content may be created at a source 14 which may include an authoring station configured to create such content. An authoring station may include a computer workstation configured with software which aids in the development of interactive content. An authoring station may be part of broadcast station 16 in which case the conveyance of the created content may be through a local computing network, or similar configuration. Alternatively, an authoring station may be remotely located 13 from broadcast station 16. In an embodiment where authoring station is not directly coupled to broadcast station 16, the content created by a source 13 may be conveyed to broadcast station 16 via Internet, broadcast, cable, etc. In some cases, content created by at a remote location 13 may first be transferred to a storage medium, such as a CD-RW, DVD, or flash memory device, and transported to broadcast station 16 via more conventional means where it may be stored in a database or other storage device.

Subsequent to its creation, content from sources 13, 14, 15 and 60 may be delivered to receiver(s) 30 through a broadcast transmission network. This network consists essentially of broadcast station 16 which assembles the content from sources 13, 14, 15 and 60 and processes the content as appropriate (e.g., digitizes, compresses, packetizes), and a transmission network 17 which receives the content 40 from broadcast station 16 and conveys it 42 to receiving device(s) 30. In one embodiment, broadcast station 16 includes software and/or hardware which is configured to process the content conveyed by sources 13, 14, 15 and 60 as described above. A second delivery mechanism may include a direct point-to-point connection 138 between receiver(s) 30 and source 18 which may be some type of server. This connection 138 may be made via an ordinary telephone line, cable, wireless, or otherwise. A third delivery mechanism may also be a point-to-point connection 136, but transmission of the content from a source 19 to receiver(s) 30 is made via one or more shared networks (e.g., over the Internet). FIG. 1 also illustrates broadcast station 16 may be optionally coupled to source 18 and/or source 19. Such a coupling may enable broadcast station 16 to work cooperatively with source 18 or source 19 in conveying content to receiver(s) 30. Also illustrated in FIG. 1 is a back channel (or return path) 26 by which receiver(s) 30 may convey to and/or receive data from broadcast station 16. Back channel 26 may comprise a telephone line, cable, wireless, or other connection.

One delivery mechanism, the direct point-to-point connection to a source of content, may comprise communication via an ordinary telephone line. This type of connection is typically initiated by the receiver(s) 30 to convey information to, or retrieve information from, a data server. Another delivery mechanism, the point-to-point connection through one or more networks, may comprise a typical connection between nodes on the Internet. Because data may be routed through many different shared networks in this case, it may be read, stored and written many times as it is transmitted from source 19 to receiver(s) 30. The third delivery mechanism may include a satellite, cable or terrestrial broadcast network 17. Information may be transmitted from and to receiver(s) 30 both in real time or store and forward.

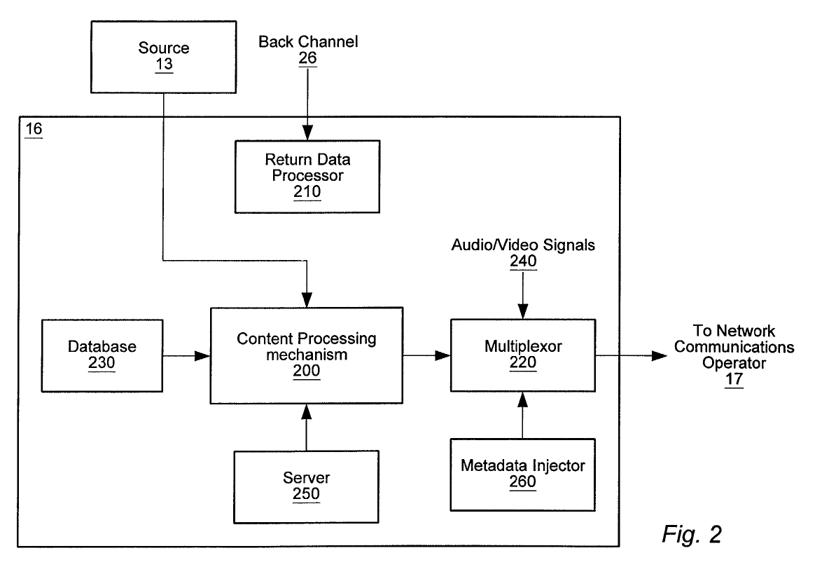

Turning now to FIG. 2, an overview of one embodiment of a broadcast station (head-end) 16 is shown. The broadcast station 16 of FIG. 2, includes an application server 250 and a database 230 which may contain previously created interactive content. Also shown in FIG. 2 is a source 13 of content which is external to broadcast station 16 and coupled to broadcast station 16. In addition, mechanism 200 and server 250 are coupled to the Internet 60. Database 230, server 250, Internet 60, and source 13 are coupled to a content processing mechanism 200 which is configured to process the content received and convey the processed content to a multiplexor 220.

In one embodiment, content processing mechanism 200 comprises a computer coupled to receive and convey content from source 13, database 230, server 250, or the Internet 60. Processing mechanism 200 is configured to convey the processed content to multiplexor 220. Multiplexor 220 is also coupled to receive audio/video signals 240. Multiplexor 220 multiplexes the received signals and conveys the multiplexed signal to network communications operator 17 where it is subsequently conveyed to a receiving device. Finally, broadcast station 16 includes a return data processor 210 coupled to back channel 26. In one embodiment, return data processor 210 may comprise a modem which receives data for further processing within broadcast station 16. While the above description describes a source of interactive content as being at a broadcast station 16, in an alternative embodiment database 230 and content processing mechanism 200 may reside at the location of a network communications operator 17. An example of such an alternative embodiment may be a cable station which inserts interactive content into a broadcast signal prior to transmission.

Targeted Messaging and Remote Recording Overview

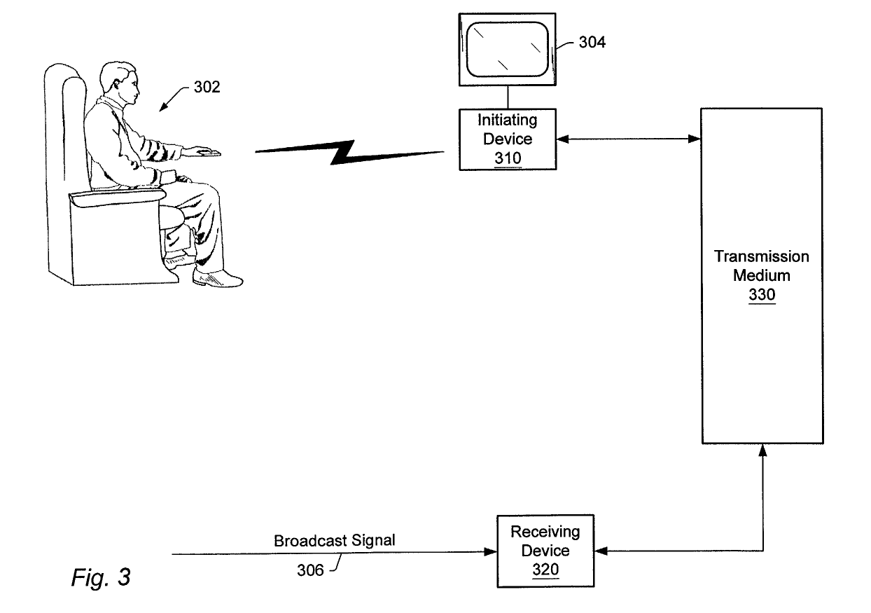

Turning now to FIG. 3, one embodiment of a system for enabling the capture of broadcast, or other, content at a remote location is shown. In the embodiment shown, a viewer 302 watching a television 304 is illustrated. Coupled to the television is an initiating device 310 such as a set-top box. While watching television 304, viewer 302 observes a particular program which he believes a friend may wish to see. Utilizing a remote control or other device, viewer 302 accesses initiating device 310 which generates a targeted message for conveyance to the friend. In one embodiment, the generated message includes an indication of the particular program and an indication identifying the friend. Subsequently, the message is conveyed to the friend's receiving device 320 via a transmission medium 330. Receiving device 320 detects the message and, in response, initiates recording of the particular program via a received programming signal 306. In one embodiment, recording of the program may begin immediately. Alternatively, receiving device 320 may be programmed to record the indicated program material at a later date. Still further, receiving device 320 may be configured to detect a broadcast signal which indicates the program material is being broadcast. Advantageously, viewer 302 is able to effectively “send” a program to the friend without consuming the bandwidth that would otherwise be required in order to actually send the program material directly from the viewer. The illustration of FIG. 3 is intended to be exemplary only. Devices 310 and 320 need not be a set-top box, but may comprise any suitable device, such as a PVR, video game console, etc. In addition, transmission medium may comprise ordinary telephone lines, cable, or any other suitable means of transmission.

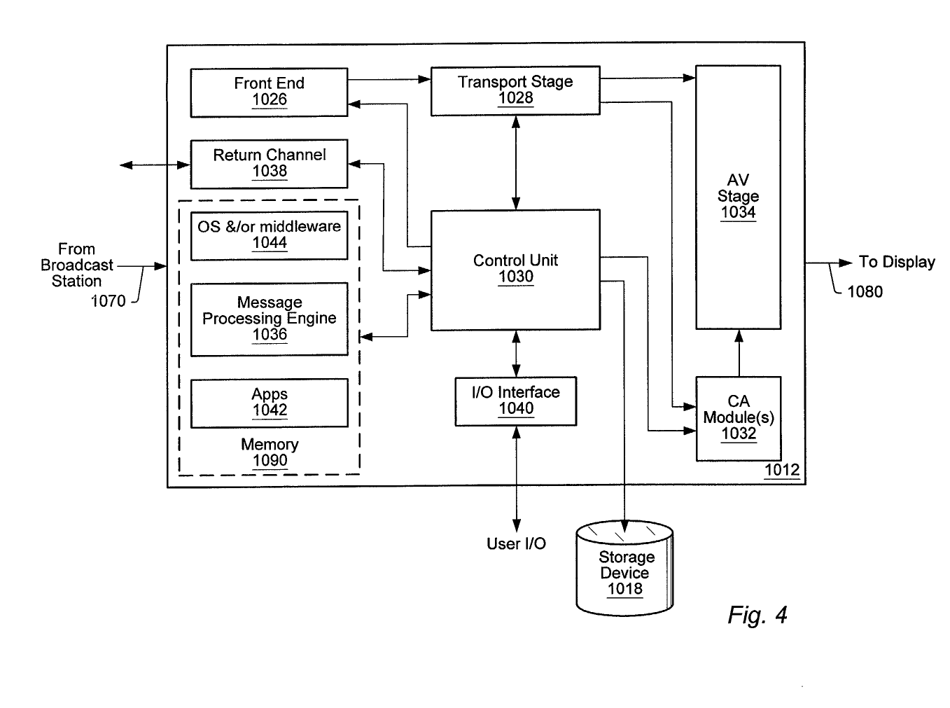

Turning now to FIG. 4, one embodiment of a receiving/initiating device 1012, hereinafter referred to as a “client” is shown. While FIG. 4 illustrates the client 1012 in the form of a set top box 1012, as mentioned above, client 1012 may comprise other devices as well. Generally speaking, client 1012 is configured to receive a first signal 1070, such as a broadcast signal, and convey a second signal 1080, such as to a display or recording device. In the embodiment shown, client 1012 is coupled to an external mass storage device 1018. Client 1012 includes a control unit 1030, front end 1026, return channel 1038, transport stage 1028, and AV stage 1034. Also represented in FIG. 4 is a memory 1080 which includes OS and/or middleware 1044, message processing engine 1036, and applications 1042. Also shown is an I/O interface 1040 and conditional access (CA) module(s) 1032. I/O interface 1040 may be configured to detect user interaction via a remote control or other device. Control unit 1030 may comprise a microprocessor, memory (e.g., RAM), and other components which are necessary to perform ordinary general purpose computing.

In one embodiment, applications 1042, OS/middleware 1044, CA module(s) 1032, and message processing engine 1036 comprise code which may be stored in a memory device of set-top box 1012. Additionally, CA module(s) 1032 may comprise system software configured to control access to particular programs or services which are accessible by set-top box 1012. While message processing engine 1036 is shown as program code which may be stored in memory 1090 and executed by control unit 1030, it is understood that other embodiments are possible and are contemplated. For example, message processing engine 1036 may comprise circuitry or a combination of hardware and software. For example, message processing engine 1036 may comprise a processing device executing program instructions. Further, message processing engine 1036 may be configured as an external device which may be coupled to a receiving unit. For example, such an external device may comprise an expansion module which is configured to add message processing functionality to a preexisting device.

Generally speaking, client 1012 is operable to receive and decompress signals which may include digital data. The decompressed signals may be converted into analog signals such as PAL, SECAM, or NTSC format signals for television display, or may be in digital format for use by a digital television display. As shown in FIG. 4, client 1012 includes front end circuitry 1026 operable to receive audio, video, and other data from a received signal 1070. The received signal 1070 is fed into the client 1012 at the front end 1026, which may comprise an analog to digital (A/D) converter and tuner/demodulators (not shown). Front end 1026 may select and pass a particular frequency, demodulate it, and convert analog signals to a digital format. While analog data may be converted to digital data, as noted above a received signal may comprise digital data which may require no such conversion. The digitized output may then be conveyed to a transport stage 1028 which further processes the data, conveying a portion of the data to an audio-visual (AV) stage 1034 for display and another portion to control processor 1030. In addition, CA module 1032 may receive data from transport stage 1028 and may conditionally convey a descrambled or other signal to AV stage 1034. Signaling and control information may also be included in the broadcast along with the audio-video data and may be manipulated by software within the client 1012.

Audio-video signals and program control signals received by the client 1012 may include television programs, relational metadata, and menu selections accessible by a viewer through a user interface, as well as applications that may be executed. A viewer may control the client 1012 in a variety of ways, including through an infrared remote control unit, a control panel on the client, or a device that is used to choose from a menu displayed on the television screen. Selections and entries made by the viewer may be intended for one or more of several applications that are executing on the client. As mentioned above, broadcast signals 1070 are received via front end 1026 and are filtered by transport stage 1028. Unicast or multicast signals may generally be received via return channel 1038. Applications 1042 which execute on the client 1012 may arrive there in a variety of ways. For example, applications may be received via a broadcast signal 1070, via the return channel resource interface 1038, or via storage device 1018. Applications received via storage device 1018 may have been shipped originally with the client 1012 or may have been downloaded previously from another source and stored on storage 1018.

In one embodiment, client 1012 may be configured as a digital set top box for use with a satellite receiver or satellite integrated decoder/receiver that is capable of decoding MPEG video, audio, and data. For example, client 1012 may be configured to receive digital video channels that support broadband communications using Quadrature Amplitude Modulation (QAM), Quadrature Phase Shift Keying (QPSK), Coded Orthogonal Frequency Division Multiplexing (COFDM), or 8-vestigial side band (VSB), and to control channels for two-way signaling and messaging. The digital channels may carry compressed and encoded multiprogram MPEG (Motion Picture Expert Group) transport streams. Transport stage 1028 extracts the desired program from the transport stream and separates the audio, video, and data components, which are routed to devices that process the streams, such as one or more audio decoders, one or more video decoders, and optionally to RAM (or other form of memory) or a hard drive. It is to be understood that the client 1012 and storage device 1018 (as well as any data and signals from the broadcast service provider) may be configured to accommodate analog, digital, or both analog and digital data. For storage of received analog data, conversion to digital format may be performed.

Storage device 1018 is optionally coupled to the client 1012 and may be configured to store video, audio, executable code, meta-data, and other data. Storage device 1018 may be internal to client 1012 or connected externally (e.g., through an IEEE 1394-1995 connection) with either a permanent connection or a removable connection. Further, storage device 1018 may comprise any suitable type of storage, such as a hard disk drive, a recordable DVD drive, magnetic tape, optical disk, magneto-optical disk, flash memory, or solid state memory. In addition, more than one storage device such as device 1018 may be attached to the client 1012. The client 1012 and/or storage device 1018 may further be incorporated into a television set. Executable data, such as program instructions, which is stored within storage device 1018 may be retrieved and executed. In one embodiment, retrieved data may be executed or otherwise utilized in synchronization with other applications or received signals, for example corresponding to a game show, commercial, or Internet based on-line game. Alternatively, retrieved data may be executed or utilized independently, such as for video-on-demand, banking, e-mail, or an electronic program guide (EPG).

It is to be understood that the client 1012 and system 100 described herein are intended to be exemplary only. Broadcast network system 100 and client 1012 may be different than described herein without departing from the scope of the invention. Further, various components depicted in the client 1012 of FIG. 4 may be combined, such as the placement of the integration of storage device 1018 within client 1012. Numerous alternatives are possible and are contemplated.

Message Processing Engine

As mentioned above, the message processing engine may be implemented in software. However, it may also be implemented in hardware which is either pre-installed, for example, or as part of a component that is inserted by the consumer. Similarly, if implemented at least partly in software, any component of the software may be pre-installed or downloaded from a broadcast or from a location referenced through a locator in a broadcast.

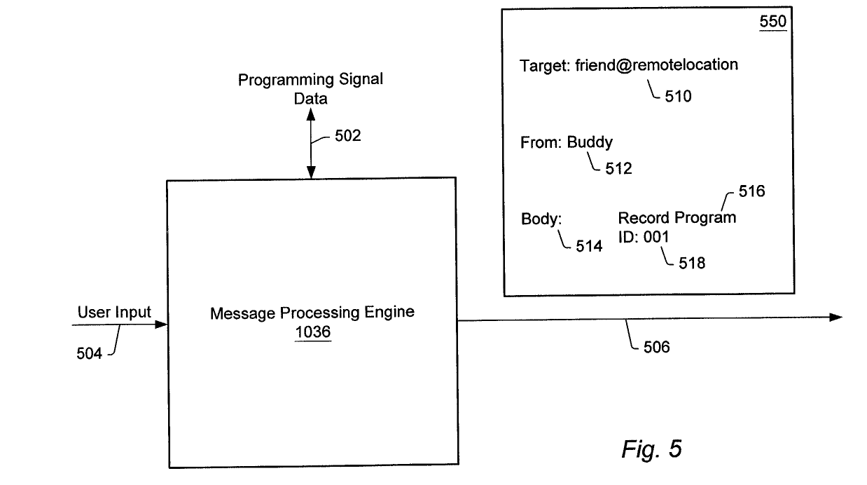

Generally speaking, message processing engine 1036 is configured to generate targeted messages for conveyance to a remote device. FIG. 5 shows one embodiment of a message processing engine 1036 and generated message 550. Message processing engine 1036 is coupled to receive programming data 502 and data corresponding to user input 504. Based on the received programming 502 and user data 504, message processing engine 1036 generates a signal 506 including message 550. In the embodiment shown, message 550 includes a target ID 510, an indication identifying the sender 512 of the message, and a body 514. In one embodiment, the target ID 510 may comprise an e-mail type identification, though the target ID 510 may include any form of identification sufficient to identify a remote target or user. Likewise, sender identification 512 may include any suitable type of identification. In the exemplary embodiment shown, body 514 includes an action 516 and corresponding information 518. Action 516 “Record Program” may serve to initiate the recording of a program. Information 518 may then serve to identify the program to be recorded. Numerous other forms of messages are possible and will be discussed further below.

In one embodiment, a viewer may be viewing a particular television program and provide input via remote control to a local device, such as a set-top box. By pressing a button on the remote control, the viewer is able to indicate a body 514 and intended target 510. In one embodiment, a graphical user interface may be presented on the television providing a list of potential targets and message types. The viewer may then provide input 504 indicating the particular body 514 and target 510 of the message. Message processing engine 1036 may then detect the user input 504 and obtain any necessary corresponding information, such as a program ID 518, from the programming signal data 502. Subsequent to generation, the message 550 is conveyed to the target device indicated by the target ID 510. As mentioned above, message 550 may be conveyed by any type of suitable transmission medium. In one embodiment, message 550 may be conveyed via Internet utilizing an e-mail type addressing scheme.

As an alterative to the above, wherein the viewer is watching the particular television program, the program material which the viewer is interested in may be stored on a storage device. For example, a viewer may have recorded program material which is stored in a PVR. The message processing engine 1036 may then be configured to receive data corresponding to the stored program material. Utilizing this data, the processing engine 1036 may generate a message for conveyance to a friend or remote receiver. Still further, the viewer initiating the message may not be receiving the program of interest and may not have a stored version of the program. Rather, the viewer may only have access to information identifying or otherwise describing the program. For example, the viewer may be able to access a catalog or guide of program information which provides identifying information. By retrieving the necessary program or data identification, the viewer may then initiate generation of the message for conveyance to the remote location. Alternatively, the viewer may be able to capture program identifying information from an advertisement for the program of interest. Alternatives such as these may be desirable for the viewer who does not wish to view or capture the program himself, but knows of a friend or other person who may.

Peer-to-Peer

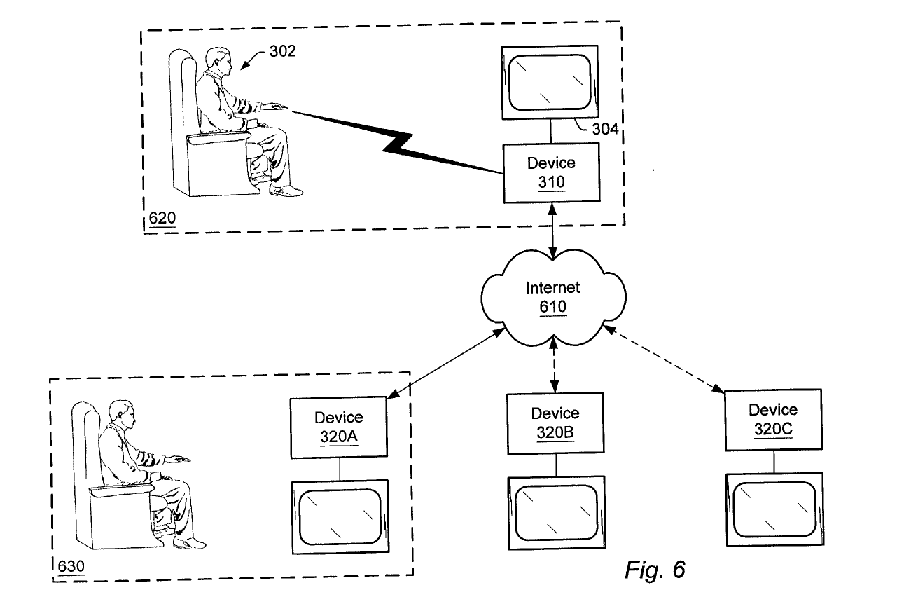

As indicated above, in one embodiment one viewer may convey a message to another viewer. Such an embodiment may be referred to as a peer-to-peer based embodiment. FIG. 6 illustrates an example of a peer-to-peer embodiment. In the embodiment shown, a viewer 302 at one location 620 initiates the generation and conveyance of a message via device 310 to a remote location 630. Device 310 is coupled to a transmission medium 610, in this case the Internet, which is further coupled to devices 320. The message is received by device 320A which then either accepts or rejects the message. If the message is accepted, the message is further processed in order to determine if a particular action is to be taken. While this example illustrates one viewer conveying a message to another single viewer, this need not be the case. Viewer 302 may generate a message which is then targeted to multiple receiving devices 320A-320C. For example, a viewer 302 may not only maintain target identifiers for individuals, but may also configure device 310 to create groups of targets. As discussed above, subsequent to receiving and processing the message, a receiving device 320 may then responsively capture program or other data which is subsequently received by the device 320.

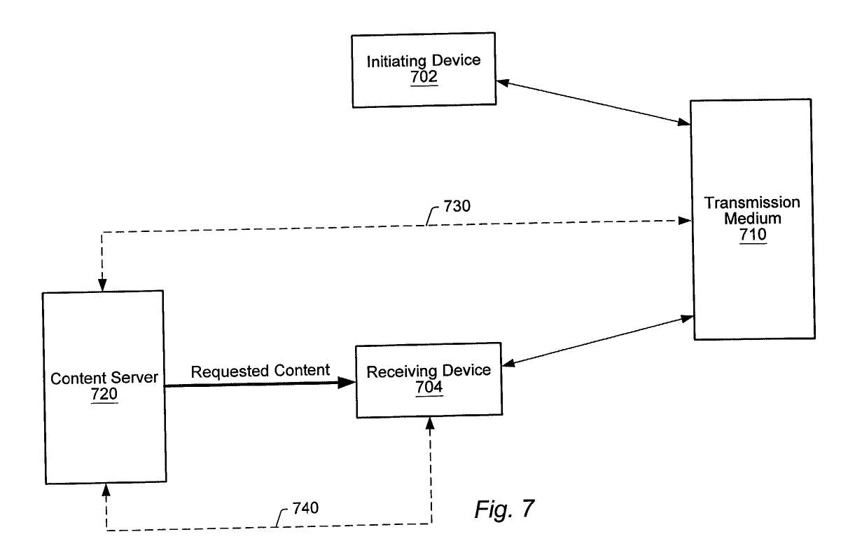

As an alternative to programming a remote device 320 to capture a subsequently broadcast programming signal, a content server may be configured to deliver desired program material or other data on a demand type basis. FIG. 7 illustrates one embodiment utilizing such a content server. FIG. 7 includes an initiating device 702 coupled to a receiving device 704 via a transmission medium 710. Also included in FIG. 7 is a content server 720 which is configured to receive and respond to requests for data. In the embodiment shown, a viewer may utilize initiating device 702 to generate a message for conveyance to a receiving device 704. As before, the message may indicate some program material or other data which the viewer wishes to be received by the receiving device 704. However, rather than generating a message which causes the receiving device to either begin recording immediately or wait for a subsequent broadcast to capture the data, a request is generated and conveyed to content server 720 for the desired program material or other data. Subsequently, the requested data is conveyed to receiving device 704 for capture.

In one embodiment, receiving device 704 may be configured to generate the request for the desired program material in response to receiving and processing the message from device 702. Conveyance of the request to content server 720 may occur immediately, or may be scheduled for a later time. Similarly, upon receiving the request, content server 720 may convey desired program material soon after receiving the request, or may schedule conveyance for a later time. Further, content server 720 may be configured to convey information to receiving device 704 and/or 702 regarding the availability of the desire program material, the time which has been scheduled for conveyance of the program material, or otherwise. For example, initiating device 702 may be configured to convey a request to content server 720 prior to generating the targeted message. Content server 720 may then respond to initiating device 702 with an indication as to whether the desired program material is available. If the program material is available, initiating device 702 may then generate the message for conveyance to receiving device 704. If the program material is not available, initiating device 702 may provide an indication to the viewer that the desired material is not available.

In one embodiment, content server 720 may be configured to convey optional times for scheduling the conveyance of the desired program material. In response, the user of device 704 and/or 702 may indicate a preferred schedule. Requests to content server 720 may be conveyed via transmission medium 710, or another medium 740. Likewise, content server 720 may convey the desired content to receiving device 704 via low speed modem connection, fiber optic cable, or any other suitable means. Utilizing a content server 720 as in FIG. 7 may be desirable in a variety of situation. For example, the desired program material or data may not be scheduled for further broadcast. Alternatively, the next scheduled broadcast may be further in the future than is desired.

Still further, in one embodiment, content and level of service options may be offered at various prices. For example, a viewer may be able to schedule a later delivery of content for a lower fee than an earlier delivery of content. Similarly, a lower bandwidth delivery option may be provided for a lower fee than a higher bandwidth option. In various options, either viewer 702 or 704 may select the desired delivery option. For example, in an embodiment where there is a fee for delivery of the desired content (e.g., a pay-per-view type service), viewer 702 may receive feedback indicating various pricing options and could prepay for delivery of the content to viewer 704. In such an embodiment, the message/edit list which was generated by viewer 702 may include a secure payment feature which pays for costs which may be associated with retrieval of the indicated content. Server 720, or an associated service, may be configured to process the included payment information. Viewer 704 may then be able to schedule delivery of the content at the level of service paid for by viewer 702. Various options may include allowing viewer 704 to upgrade to a higher level of service delivery is desired.

Additionally, by allowing the desired program material or data to be conveyed to individual receiving devices by content server 720, the program material need not be broadcast and broadcast bandwidth may be saved. Further, by allowing individual viewers such as viewer 704 decide if he or she wants to receive particular content, the content provider or operator can further avoid wasting bandwidth by not transmitting content to viewers who do not wish to receive the content.

Control Lists

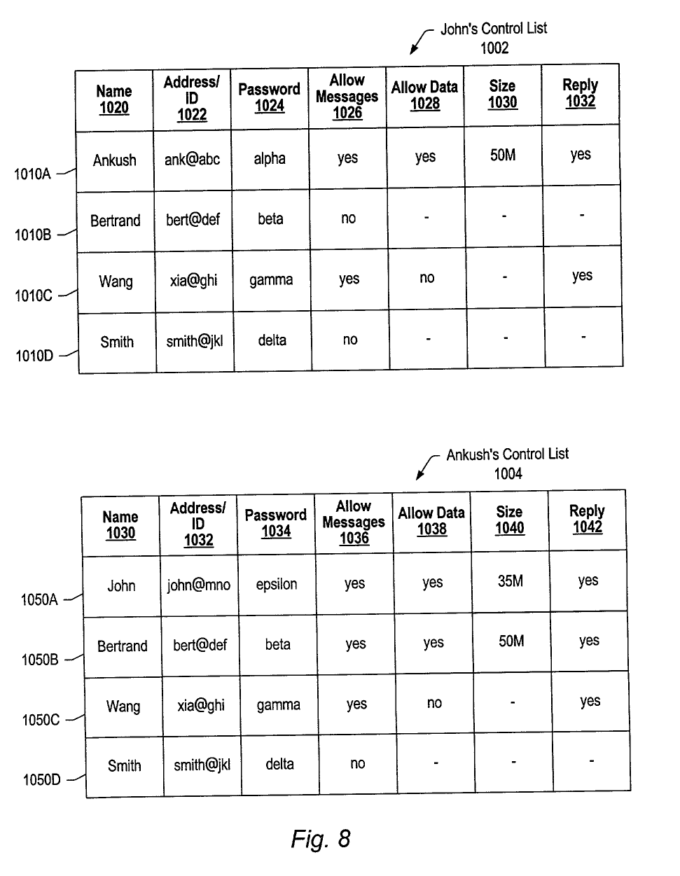

As mentioned above, when a viewer initiates generation of a targeted message, the viewer's initiating device may be configured to provide a list of potential targets. FIG. 8 illustrates one embodiment of control lists which may be maintained by initiating and receiving devices. FIG. 8 illustrates two control lists, 1002 and 1004. Control list 1002 represents “John's Control List” which may be maintained on an initiating device. Control list 1004 represents “Ankush's Control List” which may be maintained on a receiving device.

In the embodiment shown, each control list is depicted as a grid, with each row corresponding to a particular friend or target. List 1002 includes four rows, 1010A-1010D, and list 1004 includes four rows 1050A-1050D. Each column of the lists corresponds to a particular type of information. Column 1020 indicates a name of the target, column 1022 indicates an address or ID for the target, column 1024 indicates a password, column 1026 indicates whether messages are allowed or rejected from the target, column 1028 indicates whether data may be received and stored from the target, column 103 indicates how much data may be stored by the target, and column 1032 indicates whether replies are conveyed to the target. As an example, list 1002 represents a list which may have been created by a viewer names John. John's list 1002 includes entries for four friends, 1010A-1010D. Entry 1010A is for a friend who is named Ankush.

In one embodiment, the name 102 given may simply be a nickname created by the list owner, John in this case. Ankush has an Address/ID of ank@abc. In the embodiment shown, a password “alpha” is provided for Ankush. When Ankush conveys a message to John, he may also include the password which is checked against John's control list 1002. If the password does not match, the message may be rejected or otherwise registered as an attempted message. In one embodiment, such security and control may include the use of a public key type mechanism similar to that employed by Pretty Good Privacy (PGP). However, any suitable such mechanism may be used. For example, John may send his public key to Ankush through a trusted channel who then stores the public key in his control list. Subsequently, when John generates his message for Ankush, a fingerprint of the message using his John's private key is also generated. Ankush receives the message, checks that John is in his control list, and then uses John's public key stored in his control list to check that the message actually comes from John. If the fingerprint received with the message matches a fingerprint computed on the message by Ankush's receiver, the message is accepted. Numerous such techniques may be used to provide for message security. In one embodiment, an underlying security mechanism may be hidden from the viewer by utilizing more familiar paradigms such as passwords.

As shown in John's control list 1002, an entry of “yes” in column 1026 indicates messages will be allowed from Ankush. Entering a “no” in column 1026 may allow a viewer to block all messages from a particular person. Column 1028 may be used to indicate whether a particular person 1010 is permitted to enable storage of data on John's receiving device. For example, a message received from Ankush may indicate recording of a particular program is to be initiated by John's receiving device at a particular time. Entering “no” in column 1028 would disallow storage of data by that person. Consequently, one may indicate whether messages are allowed from a person while separately deciding whether they are permitted to store data. Column 1030 indicates the maximum amount of data which may be stored by that person. In this example, Ankush may initiate storage of up to 50M of data by John's device. Finally, column 1032 may be used to indicate whether replies are made to that particular person. For example, if John's storage device is full, a reply may be sent indicating this fact to the sender of the message. Alternatively, if the particular program indicated by a message has already been stored by John's device, John's receiving device may be configured to detect this and generate a reply indicating this fact. Numerous possible replies may be utilized.

In one embodiment, while watching a television program, John may initiate generation of a message to Ankush. In response, John's initiating device accesses control list 1002 and presents a list of names 1010 for John to choose from as potential targets. John selects Ankush from the list and a message is created which includes the address/ID ank@abc. John also provides an indication such as “Record This” which is included in the message. Many types of messages may be generated as discussed below.

Messages, Text and Edit Lists

One type of message, which has already been discussed, includes an indication to record a particular program. Such a message may indicate recording is to begin immediately or at a later time. Other messages may cause a message to be displayed by the target receiver, or cause the receiver to tune to a particular channel. For example, a message may include text directed to a friend informing them of a particular program. The friend may then receive an indication that a message has been received. Upon reading the text included in the message, the receiving device may be configured to provide the friend the option of initiating recording of the recommended program or not. If accepted, the recording of the program, or scheduling a recording of the program, may be automatically initiated.

While recording of an entire program or other data as discussed above may be desired, an alternative involves the capture and recording of selected portions of program material or other data items. Many times while watching a program, a viewer may wish to convey only selected portions of the program, such as a highlight of a sporting event or particular scenes of a movie, rather than conveying the entire program. In order to achieve this goal, targeted messages may be created which serve as, or include, “edit lists”. Generally speaking, an edit list describes or identifies multiple data items or portions of a program which are to be captured. Generally speaking, capturing a data item may comprise presenting or storing audio and/or visual data, or other non audio/visual data such as application data. An edit list may simply describes a single program in its entirety and perform in a similar manner to the embodiments described above.

In one embodiment, a viewer may “tag” selected portions of a program while watching the program. The program being watched may be a received broadcast, or a recorded program on a local storage device. Utilizing a remote control or other device, the viewer may simply press a button, for example, to mark the beginning and end of selected portions. When the viewer is done tagging selected portions, the viewer may then provide an indication that the list of selected portions is complete. A list describing the selected portions may then be stored locally, conveyed to a remote location for storage, or used in a message as described below. Further, a viewer may create a single list of tagged selections from multiple programs. For example, a viewer may create an edit list of sports highlights covering numerous sporting events. In an alternative embodiment, a user may tag a selected portion of a program (e.g. a particular segment in the news) and the receiver automatically figures out where the segment begins and ends based on metadata transmitted by the network operator. In embodiments where the receiving device has limited or no storage, the network operator or another external entity may optionally provide some storage capacity for viewers. For example, a receiver may be coupled to a remote storage location via Internet.

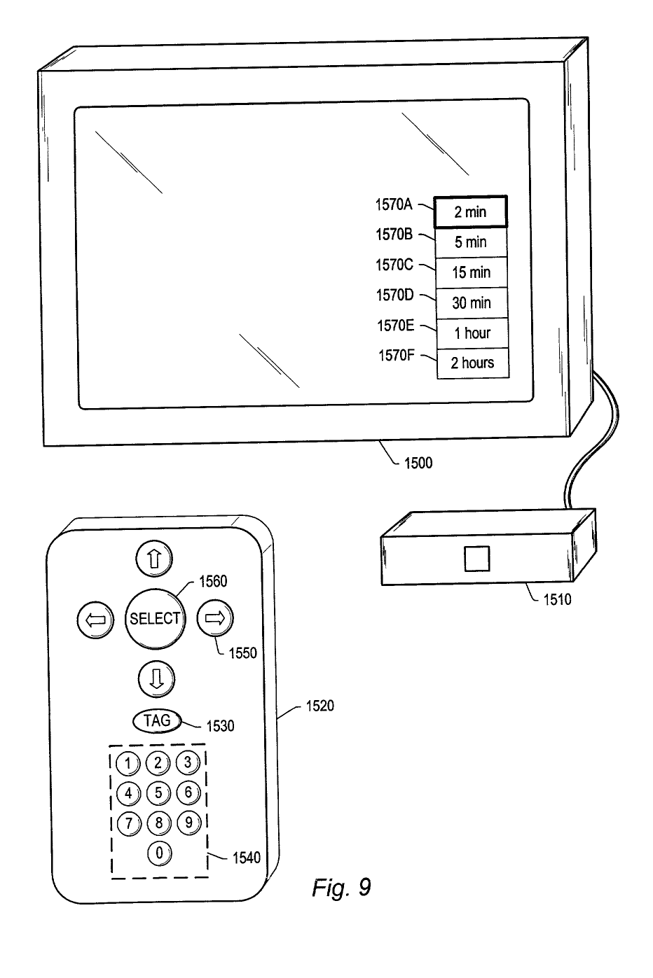

Turning to FIG. 9, one embodiment of a message 950 which serves as an edit list is shown. As in the previous example, message 950 includes an indication of the target 952, the sender 954, and a body 958. It is to be understood that these entries 952, 954, and 958 are intended to be exemplary only. Other messages may include different entries. Target 952 indicates three targets of the message, two individuals and one group. The two individuals are indicated as friend1 and friend2. A group is indicated by group1. In one embodiment, each of the targets 952 may simply be indicated by nickname which is then looked up in a control list or other target list. A lookup performed on each target may reveal the actual address or ID required for transmission of the message. Further, looking up a nickname may reveal that the nickname represent a number of targets which may automatically be utilized for conveyance of the message. Also included in FIG. 9 is a password entry 956 “crypto”. In various embodiments, the password and/or other elements of the message may be encrypted prior to conveyance. In addition, an optional expiration date 962 is included. In one embodiment, an expiration date may be used to indicate that if any actions indicated by the message 950 are not performed within a certain period of time, the action is not to be performed.

In the example of FIG. 9, the message body 958 includes five entries 960A-960E. The first entry 960A provides text “Check this out!” which may be displayed when the message 950 is received, or when a viewer otherwise accesses the message at the receiving device. An action 960B “Record Selections” is included which indicates an action to be taken. A program material or data identifier 960C “001” is also included which identifies a particular data or program stream. Finally, two selections 960D-960E are included which indicate two portions of the data identified by identifier 960C which are to be captured and/or recorded. As an example, assume identifier 960C identifies a particular movie. Event1 960D identifies a first segment of the movie. In the example shown, a relative time based approach is illustrated. Event1 960D is indicated to start at time 0:04:30 and end at time 0:06:00.

In one embodiment, the times indicated by 960D-960E may be relative to the beginning of the identified program 960C, for example. A second segment 960E indicates a start time of 0:23:30 and end time of 0:29:00. Advantageously, only the portions 960D-960E of the program 960C which are of interest are recorded. Alternatively, the device receiving the message 950 may be configured to record the entire program 960C and then “edit” the recorded program to leave only the indicated portions 960D-960E remaining. Also, the receiving device may be configured to view the indicated selections individually or as a sequence. Further, in a demand type embodiment as described above, only the selected portions 960D-960E may be requested and received from a remote content server. Still further, an edit list may be created by a viewer which indicates that the selected portions described by the edit list are to be reconstructed as a sequence at the remote location in an order different than they originally appeared. In this manner, the viewer is able to effectively produce their own version of a movie or other program.

Editing Local Content and Edit List Catalogs

In the discussion above, embodiments have been described which involve first receiving a message, and then receiving corresponding program content or other data. However, edit lists may also be used with data which has already been stored at the remote location. For example, a viewer may create an edit list describing a particular sequence of movie scenes. The edit list created by the viewer may indicate that the movie scenes are to be reconstructed in a particular sequence different than their original sequence. The viewer then initiates creation and conveyance of a message including the edit list to a remote location. The device at the receiving location receives and processes the message. The receiving device is configured to detect that the program material indicated by the message has already been recorded by the receiving device, or a storage device coupled to the receiving device. In response to detecting the program material already exists locally, the receiving device is configured to recreate the sequence of movie scenes indicated by the message from the local content. In one embodiment, the receiving device may be configured to initiate copying of the indicated movie scenes in the indicated order from the already existing material to another location on a local storage device. Advantageously, the existing program material is undisturbed and “new” program material is created which corresponds to the received message.

In addition to the above, viewers may create messages and/or edit lists which may then be accessed by others. In one embodiment, viewers may store/post their created messages on a remote server which is accessible to many viewers. Alternatively, viewers may store their edit lists locally and make them available for access to many other viewers. In such an embodiment, the edit lists need not include an indication designating a particular target. These stored messages may include the name of the posting viewer, or a description of the message to both facilitate searching and to describe the data or program content which is intended to be captured in response to the message. Viewers may then search for messages of interest. For example, a viewer may utilize a keyword based search utilizing terms such as “comedy”, “football”, “geopolitics”, or the name of a particular viewer whose selections they typically like. Numerous types of search engines are possible and are contemplated. In response to a search, a viewer may be able to browse a list of messages matching the search criteria and select one or more lists for retrieval or access. A retrieved or accessed list may then be utilized to re-create the described content locally in a manner as described above. Turning now to FIGS. 9-13, a variety of embodiments are presented which illustrate some examples of tagging.

Past Event Tagging

In one embodiment, a viewer may tag desired content by “marking” the beginning and the end of the desired portion. For example, a viewer may press a button on a remote control at the start of the portion and again press a button at the end of the portion. However, in some cases a viewer may wish to tag a program or event only to find much of it is already over. Similarly, it is not uncommon for a viewer to forget about a program they had been planning to watch. Subsequently, the viewer may be channel surfing while watching television and come upon the program after it has already begun. Consequently, the viewer is faced with the decision of watching the remainder of the program without benefit of having seen the first part or missing the program entirely. Alternatively, the viewer may not even have time to watch the remaining portion of the program. In some cases, the viewer may be able to watch the program at a later date if it is broadcast again. However, the program may not be re-broadcast and even if it is the viewer may miss it again. Such scenarios are common experiences of for television viewers.

In a second example, a viewer may be watching television when a break in a program occurs and an advertisement begins. The viewer may decide to utilize this break to obtain food or drink from the kitchen. Subsequently, the viewer returns and sees the end of an advertisement for a product or service which appeals to them and which they believe would also appeal to a friend. Unfortunately, important information regarding the product or service, such as where it may be obtained, may have been missed. Consequently, the viewer may not be able to obtain needed information regarding the product or service to make a purchase. Further, even if the viewer could view the entire advertisement at this time, the viewer may rather view it at a later time which is more convenient.

If the missed portion of the broadcast desired by the viewer was buffered in a receiver as described in the commonly assigned, co-pending patent application entitled: “System and Method for Incorporating Previously Broadcast Content into Program Recording”, Ser. No. 09/630,646, filed Aug. 2, 2000, by Pierre, et. al., the disclosure of which is incorporated herein by reference in its entirety, the buffered portion may be recorded for later viewing. Alternatively, the missed portion may be recorded where the missed information was related to the viewed information and buffered using a system and method as described in the commonly assigned, co-pending patent application “System and Method for Providing Multi-Perspective Instant Replay”, Ser. No. 09/765,965, filed Jan. 19, 2001, by Hensgen, et. al., the disclosure of which is incorporated herein by reference in its entirety. However, in many cases the missed portion which is desired by the viewer is not buffered in the viewer's receiver and may not be recorded for later viewing.

Time Based Tagging

FIG. 9 illustrates one embodiment of a mechanism for tagging events based on specified time intervals. Illustrated in FIG. 9 are a display device 1500, receiving device 1510, and a remote control device 1520. In the embodiment shown, receiving device 1510 may comprise a set-top box configured to receive a broadcast signal, and display device 1500 comprises a television. Receiver may receive a broadcast signal via cable, modem, wireless, Internet, or other suitable means. The receiving device 1510 is coupled to television 1500 and may be configured to convey a selected channel for display on display device 1500. Further, receiver 1510 may be configured to record received broadcast programs and other content on a mass storage medium within the receiver 1510. Finally, remote control 1520 is configured to communicate with receiver 1510 via infrared signals, or any other suitable manner. While the embodiment shown illustrates a separate receiver 1510, other embodiments may include the circuitry of receiver 1510 within a display device 1500. Additionally, rather than receiver 1510 including a mass storage medium, receiver 1510 may be coupled to a mass storage medium, such as a Personal Video Recorder (PVR) or videocassette recorder (VCR) which is configured to store broadcast programs. Those skilled in the art will recognize that many configurations are possible.

The embodiment of the remote control 1520 illustrated in FIG. 9 includes a numeric pad 1540, directional arrows 1550, and a select button 1560. In addition, remote control 1520 includes a tag (TAG) key 1530. In one embodiment, numeric keypad may be configured to directly enter television channel numbers and other selections which are commonly selected with television remote controls. In addition, arrow keys 1550 and select button 1560 may be utilized to traverse graphical user menu items and the like which may be displayed on the display 1500. TAG key 1530 is used to tag a programming stream. It is noted that rather than utilizing a remote control, a user may use a mouse, voice recognition apparatus, handwriting recognition device, or any other suitable mechanism for conveying an indication. Many user interface variations are possible.

In the embodiment shown, when a user presses TAG key 1530, receiver 1510 detects the key press and may cause a menu 1570 to be displayed on television display 1500. Menu 1570 includes items 1570A-1570F for selection. Each of items 1570A-1570F indicate a period of time which is past where the viewer would like the tagged portion to begin. For example, a viewer may select item 1570A in order to tag the currently selected program beginning 2 minutes in the past. In the case where a viewer has missed the beginning of an advertisement, beginning a tag from 2 minutes earlier may be sufficient to capture the beginning of the advertisement. If a viewer wishes to tag a portion from a period of time beginning 30 minutes in the past, the viewer may select item 1570D. In this manner, the viewer is able to specify the beginning of the desired portion even when that “beginning” occurred in the past. While a receiving device may be configured to buffer a portion of a received broadcast signal, the portion which a viewer indicates a desire to tag may not be present in the buffer. Alternatively, the receiving device may not include any ability to buffer broadcast material.

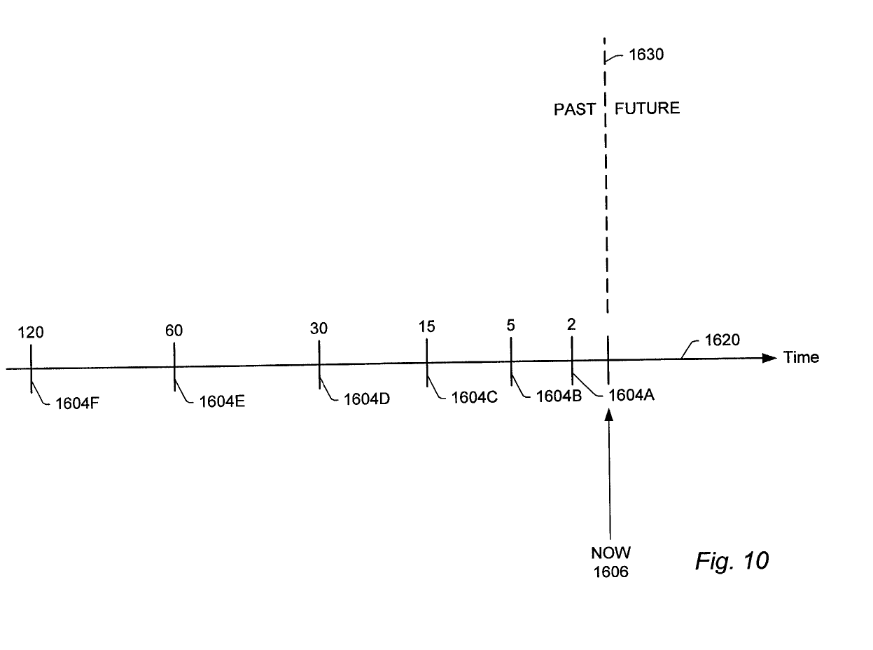

FIG. 10 illustrates a different perspective of the above embodiment. Illustrated in FIG. 10 is a timeline 1620 which corresponds to a broadcast stream. All items to the left of separator 1630 corresponds to events that have occurred in the past, and all items to the right of separator corresponds to events in the future. Hash mark 1606 on the timeline 1620 indicates the present. Each of hash marks 1604A-1604F correspond to a number of minutes in the past from 2-120. Consequently, if a viewer were to provide a tag indication corresponding to the past 15 minutes 1604C, a message may be generated indicating that the corresponding past 15 minutes are part of the desired portion.

In one embodiment, when a viewer initiates a past event tag, not only is the corresponding past program stream tagged (all parts of the desired portion may be considered to be “tagged”), but a programming signal subsequent to the viewer's present indication is also tagged. For example, if a viewer initiates a tag beginning at a point 20 minutes in the past, tagging of the currently displayed programming stream is also initiated beginning at the present. Tagging of the corresponding program stream may then continue indefinitely, or until the viewer actively stops the tagging.

In an alternative embodiment, a viewer may select not only a period of time in the past to be tagged, but also a duration or subsequent period of time to tag. For example, if a viewer is viewing the middle of a one hour program and wishes to tag the entire program, the viewer may select a menu item corresponding to 30 minutes in the past in order to capture the first half of the program. In addition, in one embodiment a second menu item may be presented which permits the viewer to select a total duration for the tagged portion, or alternately a period of time subsequent to the present. If a total duration menu item is presented, the viewer may select a menu item corresponding to one hour. Consequently, the next 30 minutes of the program will be tagged, as well as the past 30 minutes. If a subsequent duration menu item is presented, a viewer may select a subsequent duration or 30 minutes. Consequently, the next 30 minutes will be tagged, as well as the past 30 minutes. In either case, the viewer may be offered the opportunity to indicate the duration of the tagged portion.

Rather than using menu items as described above, many other possible embodiments are possible and contemplated. For example, TAG button 1530 may be configured such that it may be pressed a number of times to indicate a past period of time which is to be tagged. For example, if a viewer presses TAG button 1530 once, the past two minutes are tagged. If a viewer presses TAG button 1530 twice, the past five minutes may be tagged, and so on. With each press of TAG button 1530, a corresponding indication may be presented on a display 1500 indicating the current selection. Likewise, in an embodiment where a viewer also indicates a duration of the recording and storage, multiple presses of button TAG 1530 may also be utilized. In such an embodiment, a viewer may press TAG button 1530 to indicate a period of time which has past to tag, and then press SELECT button 1560 to enter the selection made with TAG button 1530. A viewer may then be able to press TAG button 1530 again to select a duration in a similar manner.

Event Based Tagging

In the above described embodiments, viewer selections of desired portions of a programming signal are based on durations of time specified by the viewer. For example, a viewer could select a period of time corresponding to 2, 15 or 30 minutes, etc. However, in many cases a viewer may simply wish to tag a particular event, rather than specifically indicating the begin and end of a desired portion. For example, a viewer may see a portion of an advertisement and wish to simply indicate that the advertisement is to be tagged. Similarly, if a viewer misses the first portion of a movie, they may wish to simply indicate that the entire movie is to be tagged. In the following discussion, a method and mechanism for event based tagging is described.

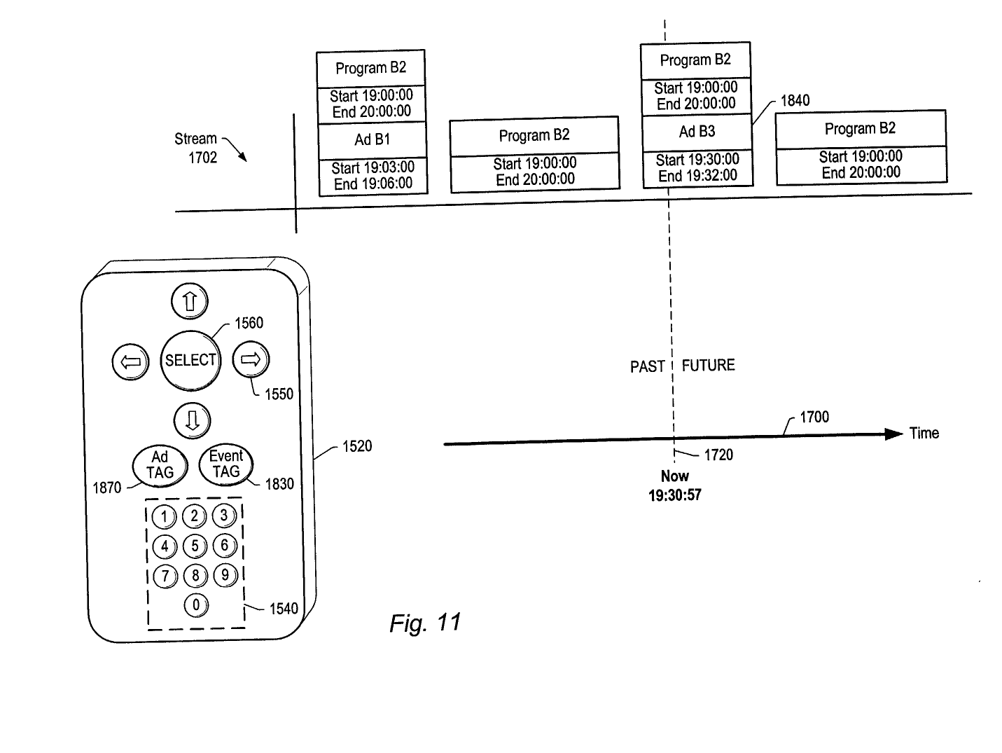

In one embodiment, a programming stream is broadcast which includes additional information corresponding to the programs and events included within the programming stream. Such additional information may include the start time and end times, or duration, of a program. FIG. 11 illustrates one embodiment of additional information which may be conveyed with a programming stream. In the embodiment shown, information corresponding to two programming streams 1701 and 1702 are illustrated. Also shown is a timeline 1700. A point in time designated “Now” 1720 is also indicated. Points on timeline 1700 to the left of mark 1720 correspond to the past and point to the right of mark 1720 on timeline 1700 correspond to the future. In the embodiment of FIG. 11, information corresponding to programs, such as movies 1730 and advertisements 1740, which are included in programming stream may be broadcast in a repeated manner. When a viewer tunes to a particular channel or programming stream, information corresponding to the selected stream may be accessible as well. For example, at the time 19:30:57 indicated by mark 1720 (where the time is indicated according to a 24 hour clock), a viewer may be tuned to the programming stream 1702. At this time 1720, corresponding information 1740 indicates an advertisement, Ad B3, is currently being broadcast. Further, the start and end times of the advertisement are included in information 1740. Information 1740 indicates the advertisement started at 19:30:00 and ends at 19:32:00. However, the current time 1720 is indicated to be 19:30:57. Consequently, the advertisement began 0:57 seconds ago and the viewer may have missed the first portion of the advertisement.

In the time based embodiments previously discussed, the viewer may choose to tag the advertisement from a specified period of time in the past. However, the viewer may not know exactly when the advertisement began and must guess at a previous period of time. In order to ensure the entire advertisement is tagged, the viewer may have selected a larger than necessary period of time, e.g., 2 minutes, not knowing only 0:57 seconds have transpired. Using this approach repeatedly may result in a waste of mass storage space. In an event based past event programming embodiment, the additional information 1740 is utilized to tag only the desired event. For example, at time 19:30:57 a viewer may indicate a desire to tag advertisement B3. Utilizing an internal clock, received time signal, time stamps contained within the received programming streams, or other data, a receiver may detect the information 1740 corresponding to the advertisement to tag only that portion of the stream corresponding to the advertisement. In the present example, the portion of stream 1702 corresponding to the time period 19:30:00-19:32:00 may be tagged and a corresponding message may be generated. Advantageously, the entire desired event, and only the desired event, is tagged.

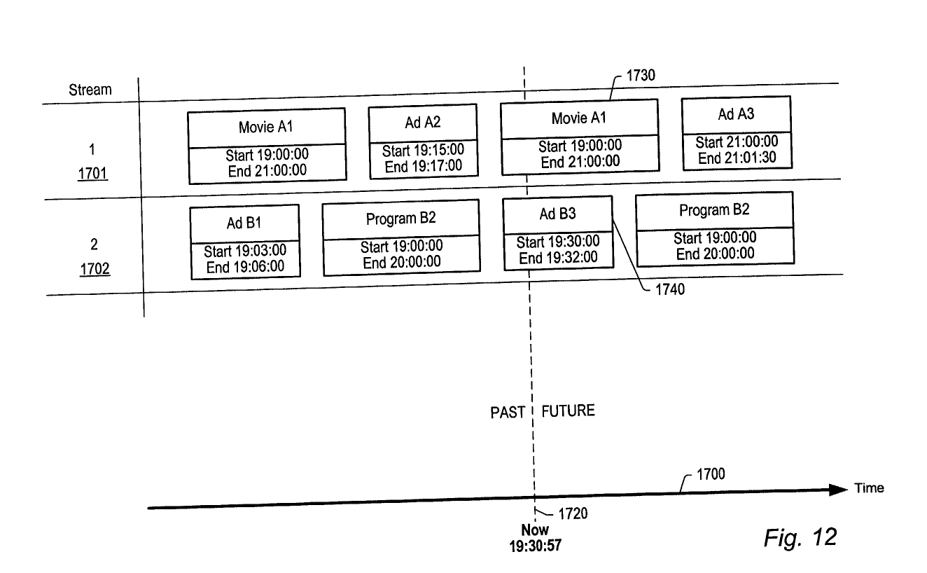

In an alternative embodiment, advertisement information may be combined with other program information to provide a viewer flexibility in making a selection. FIG. 12 illustrates an embodiment utilizing combined information. FIG. 12 illustrates the timeline 1700 of FIG. 11 and the present time 1720. Corresponding to time 1720 is programming information 1840. In the example shown, information corresponding to a program B2 and an advertisement B3 are available simultaneously. Based on the current time 1720 which is indicated to be 19:30:57, it may be determined that an advertisement B3 is currently being broadcast (advertisement B3 has a start time of 19:30:00 and an end time of 19:32:00). In addition, based on other data within information 1840, it may be determined that the current time period corresponds to a program B2 with a start time of 19:00:00 and an end time of 20:00:00. Consequently, in addition to determining a time period corresponding to an advertisement which is currently being broadcast, a program which is scheduled for that time period may also be determined.

Utilizing the combined information 1840 which may accompany a programming stream, a viewer may have increased flexibility in indicating what portion of the programming stream is to be tagged. Illustrated in FIG. 12 is one embodiment of a remote control 1820. Included in the remote control 1820 are a TAG button for advertisements 1870 (Ad TAG) and a TAG button for program events 1830 (Event TAG). In one embodiment, a viewer may indicate a desire to tag an advertisement which is currently being broadcast by pressing the Ad TAG button 1870. For example, at a time 1720 indicated on timeline 1700, a viewer may press Ad TAG button 1870 which initiates storage of the advertisement B3 corresponding to time period 19:30:00 to 19:32:00. Alternatively, at time 1720 indicated on timeline 1700, a viewer may press Event TAG button 1830 which initiates tagging of the program B2 which corresponds to the time period 19:00:00 to 20:00:00. Advantageously, a viewer may indicate a desire to tag the program scheduled for the current time period even though an advertisement is currently being broadcast.

In one embodiment, if a viewer initiates tagging of a program such as B2 utilizing information 1840, the entire programming stream for the time period 19:00:00 to 20:00:00 may be stored, including all advertisements and other material broadcast during that time period. Alternatively, only the programming stream corresponding to the program B2 may be stored and broadcast material such as advertisements may be excluded from storage. In one embodiment, a received programming stream may include an indication, such as a cue, which permits distinctions to be made between advertisements and non-advertisements. Such indications may be utilized to detect and exclude advertisements from being tagged if desired. For example, in one embodiment information such as 1840 accompanies a programming stream. If at time 1720 a viewer then indicates a desire to tag program B2, the receiving device may be configured to detect advertisements in the programming stream and not tag them. Further, while tagging the remaining portion of the program B2 as it is broadcast, the receiving device may be configured to detect advertisements as they are broadcast and exclude them from being tagged as well. Many alternatives to detecting and excluding advertisements or other programming from storage are possible and are contemplated. Further, many alternative configurations for remote control 1820 are possible as well. Rather than using dedicated buttons 1830 and 1870, a menu based system may be utilized which presents various options to a viewer.

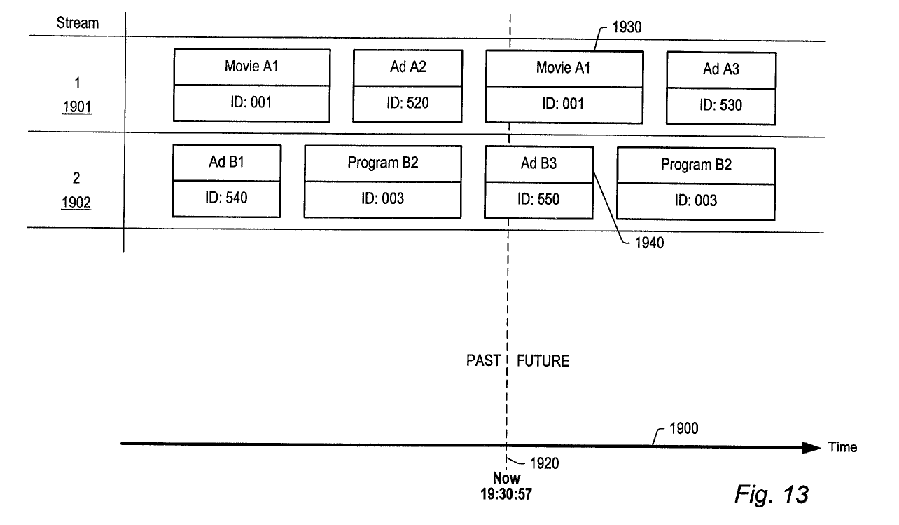

Turning now to FIG. 13, an embodiment which utilizes program ID information is illustrated. In the example shown, two streams 1901 and 1902 are illustrated. In addition to programming content, streams 1901 and 1902 include data about the program information. In one embodiment, each program or other piece of content has a unique ID. For example, movie A1 1930 has an ID of 001. Ad B3 1940 has an ID 550. In this embodiment, tags generated by a viewer utilize these identifiers. Consequently, if a viewer tags movie A1 1930, a message may be generated which includes the ID of the movie. A remote server may then be configured to utilize this identifier in order to identify the corresponding content. Various combinations of the above described embodiments are possible and are contemplated.

Finally, in one embodiment, a viewer may create a message which targets himself. In such an embodiment, the viewer may seek to have desired content conveyed from a remote server to his own device. This may be desired where, for example, the viewer has missed a portion of a movie or simply would like to record the entire content. In addition to the above descriptions, in one embodiment a viewer may be able to indicate in the message when the requested content is to be conveyed from the remote server. For example, a viewer may be able to provide an indication that requested data is to be conveyed during the middle of the night, during the day while at work, or any other suitable time. In this manner the viewer may schedule conveyance for a time in which television viewing, web surfing, phone calls and other activities will not be impacted by a receipt of program data which is configured to utilize multi-use devices. As an example, a viewer may be watching television and engaging in an interactive television game simultaneously. The receiver being used by the viewer may be configured to both receive interactive television services and provide Internet based web browsing. Further, the receiver may be configured to provide for tagging as described above. In one embodiment, the receiver may utilize the same modem for both the Internet based web surfing and the past event recording services. If conveyance of the requested content were to occur while the viewer was engaged in an Internet based interactive game, game performance may suffer is the bandwidth is not adequate to handle both simultaneously. However, by scheduling conveyance for a later time, this impact on the viewer's game play may be avoided. In various embodiments, policies regarding which activities take precedence under given circumstances may be established by the viewer, the network operator, or both. In addition, default policies may be established by the viewer or network operator which may remain in effect until overridden.

Operator Targeting

While the above description generally describes a peer-to-peer approach, an operator oriented embodiment may be utilized as well. Television system operators generally wish to provide programming and services which are most desired by their programming audience. Consequently, operators and related service providers frequently make efforts to obtain demographic and other related information on their audience in order to help determine what programming or service would be most suitable. Advertisers in particular are interested in reaching their target audience. However, even with knowledge about its viewing audience, an operator is generally not able to tailor its programming to a very fine degree of granularity. In other words, an operator is generally not able to deliver one program to one person while delivering a second program to his neighbor. Rather, an operator typically provides a number of programs to all of its audience, and each audience member searches for and selects whatever is of interest to them. Further, once an audience member selects a particular program, each member of the audience viewing that program will see the same material.

FIG. 10 illustrates one embodiment of an operator oriented embodiment in which the operator may have greater control of what material is presented to each audience member. Included in FIG. 10 is an operator 900 and receiving clients 910A-910D. Each of clients may typically be located in homes of viewing audience members, but may be located at any suitable location. In the embodiment shown, operator 900 is coupled to convey edit lists 902 and a broadcast signal 904 to clients 910. Edit lists 902 and broadcast signal 904 may be conveyed via the same medium or different transmission media. Operator 900 is configured to convey particular edit lists 902 to one or more of clients 910A. Operator 900 may utilize any suitable means for gathering information about the owners of each of clients 910 in order to create edit lists specific to audience members. For example, clients 910 may be configured to automatically gather data on the viewing habits of the owners of each clients 910 and convey that information back to the operator. Alternatively, viewers may provide information about themselves interactively through clients 910 in questionnaires. Still further, operator 900 may create edit lists for specific geographic regions. In this manner, advertising for services which are available in only particular areas may be targeted to those areas. Numerous methods of gathering information are possible and are contemplated. Based on this information, operator 900 may create viewer profiles and lists which are targeted to viewers at each client 910 location. Subsequently, operator 904 may convey a broadcast signal 904 to all clients 910. Broadcast signal 904 may contain a variety of programs, advertisements, audio, video, and other data. Clients 910 may then be configured to utilize edit lists 902 in order to select particular programming material which may be of most interest to the viewers at that location.

For example, clients 910 may be configured to generate tailored program guides which rank the available programs according to their perceived desirability by the viewer. Alternatively, virtual channels may be created which present material targeted to a particular viewer. For example, clients 910 may be configured to create virtual channels for movies, sports, and news. Clients 910 would then search all available program material and, utilizing the edit lists, present the highest ranked program on each virtual channel. A single virtual channel may capture programming material from more than one programming channel. Further, while watching a particular program, advertisements may be selected for presentation to the viewer based on the edit lists. In this manner, two neighbors watching the same program could be presented different advertisements. Numerous alternatives are possible and are contemplated.

Operators may utilize edit lists to create specific programming as well. For example, during a three week period involving a national crisis, a network or other service provider may amass a large amount of data and programming material related to the crisis. An operator can of course create particular programming from the gathered material and convey that programming to its audience, but different audience members may wish to see different material. For example, one viewer may be interested in seeing material related to international reaction to the national crisis, while another viewer may be interested in viewing the response of the national government to the crisis. To serve the various audience members desires, an operator may create edit lists which correspond to various desires. For example, based on the material which has been amassed, an operator may create one edit list which describes material on international reaction, and another edit list which describes material related to the response of the national government. Any number of different edit lists may be created. These operator created edit lists may then be made available to the viewing audience. In one embodiment, an operator may broadcast advertisements for various edit lists which may then be accessed by a member of the viewing audience. Alternatively, an operator may create an edit list “guide” which is accessible to viewers. Viewers may, for example, search the guide and access lists of interest. Any suitable means of making the lists available to the audience may be employed.

Subsequent to accessing or obtaining one or more of these edit lists, the corresponding program material or other data may be captured. Capture of the program material may be demand based, scheduled, or otherwise as described above. In the above operator oriented approach, the operator created the edit lists and determined which viewers would receive them. In this alternative approach, the operator creates the edit lists, but the individual audience members may actively decide what they will view or capture. As indicated above, viewer profiles may be developed to improve targeting of program material and other content. For example, targeting can be refined over time by gathering information on viewers, their viewing habits, how they respond to particular targeted data, and so on.

In addition to the above, a viewer's receiving device may be configurable to create virtual channels whose content is based on edit lists indicated by the viewer. For example, a viewer may configure his receiving device to create a virtual channel dedicated to international politics based on edit lists which are regularly generated by a particular operator or service provider. The program material which is received may be broadcast, conveyed via modem, or otherwise. In such an embodiment, the receiving device may be configured to periodically receive the particular edit lists which are then used to generate the virtual channel. Alternatively, the receiver may be configured to capture the desired edit list(s) and record corresponding program material for later viewing. Numerous embodiments, alternative, and combinations of the above are possible and are contemplated.

Various embodiments may further include receiving, sending or storing instructions and/or data implemented in accordance with the foregoing description upon a carrier medium. Generally speaking, a carrier medium may include transmission media or signals used in broadcast systems and otherwise such as electrical, electromagnetic, or digital signals, conveyed via a communication medium such as network and/or a wireless link. For example, a network operator may convey signals which describe program instructions via a broadcast system. A carrier medium may also include storage media or memory media such as magnetic or optical media, e.g., disk or CD-ROM, volatile or nonvolatile media such as RAM (e.g. SDRAM, RDRAM, SRAM, etc.), ROM, etc.

It is to be understood that the above embodiments are intended to be exemplary only. Numerous alternative configurations are possible and are contemplated.

What is claimed is:

1. A method for recreating data at a remote location in a television system comprising:
generating a message at a first location, wherein the message identifies a first data;
conveying the message;
processing the message at the remote location; and
recreating the first data at the remote location in response to processing the message.

2. The method of claim 1, wherein the message comprises an edit list which identifies the first data.

3. The method of claim 2, wherein the message further comprises a target identifier which identifies the remote location, and wherein conveying the message comprises sending the message to the remote location.

4. The method of claim 3, wherein the message is generated by an individual viewer.

5. The method of claim 1, wherein generating the message comprises a viewer tagging program material.

6. The method of claim 5, wherein the first data comprises two or more selected portions of the program material.

7. The method of claim 5, wherein the program material is tagged as it is received via a programming signal.

8. The method of claim 5, wherein the program material is stored in a mass storage device at the first location.

9. The method of claim 2, wherein the message is generated by an operator.

10. The method of claim 9, wherein the operator determines which members of a viewing audience are to receive the message, and conveys the message to those members.

11. The method of claim 9, wherein the operator makes the message available for access by members of a viewing audience, and wherein individual audience members determine whether or not to access the message.

12. The method of claim 9, wherein the message is received by a member of a viewing audience, and wherein the edit list is utilized to generate a virtual programming channel at the member's location.

13. The method of claim 9, wherein the operator generates additional messages, each of which are configured to recreate particular programming, and wherein each of the messages are conveyed to particular audience members identified by the operator as fitting a profile corresponding the message conveyed to the particular audience member.

14. The method of claim 1, wherein recreating the first data comprises:
receiving a programming signal;
capturing the detected first data.

15. The method of claim 14, wherein said first data is captured in response to detecting said programming signal corresponds to a predetermined time.

16. The method of claim 14, wherein said first data is captured in response to detecting a first signal in said programming signal, wherein said first signal indicates said first data is included in said programming signal.

17. The method of claim 1, wherein processing the first data comprises:
generating a request for the first data; and
conveying the request to a remote content server.

18. The method of claim 13, wherein recreating the first data comprises receiving the first data in response to the request.

19. The method of claim 2, wherein the message is conveyed for storage in a location accessible by a plurality of viewers.

20. The method of claim 13, further comprising searching an edit list catalog, identifying the message, and accessing the message.

21. A client for use in a television system comprising:
a receiver configured to receive a programming signal;
an I/O interface; and
a message processing engine configured to:
receive a first data identifying a data item;
receive a second data corresponding to user input; and
generate a message identifying the data item in response to detecting the second data, wherein the message is configured to enable recreation of the data item at a remote location in response to being processed.

22. The client of claim 21, wherein the message comprises an edit list.

23. The client of claim 22, wherein the message processing engine is further configured to generate the message with a target identifier which identifies the remote location, and wherein the client is configured to convey the message to the remote location.

24. The client of claim 21, wherein the second data corresponds to a tag generated by the user.

25. The client of claim 22, wherein the message identifies multiple data items which correspond to two or more selected portions of programming material.

26. The client of claim 21, wherein the message processing engine is configured to access a mass storage device coupled to the client, and wherein the message processing engine is configured to recreate the data item from data which is stored on the mass storage device.

27. The client of claim 25, wherein the client is configured to utilize the message processing engine in order to generate a virtual channel with programming based on the edit list.

28. The client of claim 21, wherein the message processing engine is further configured to access a remote location, search for a desired edit list, and access the desired edit list.

29. The client of claim 22, wherein the message processing engine is further configured to:
receive a second edit list;
receive a signal;
detect data within the signal which is identified by the second edit list; and
capture the detected data.

30. The client of claim 22, wherein the message processing engine is further configured to:
generate a request for the signal;
convey the request to a remote location; and
receive the signal in response to the request.

31. A system for recreating data at a remote location in a television system comprising:
a first device configured to generate a message in response to viewer input, wherein the message identifies a first data;
a second device configured to:
receive and process the message;
receive second data including the first data; and
capture the first data responsive to processing the message and detecting the first data within the received second data.

32. The system of claim 31, wherein the message includes a target identifier which identifies the second device, and wherein the first device is configured to convey the message to the second device.

33. The system of claim 31, wherein the first data corresponds to television programming material.

34. The system of claim 31, further comprising a remote content server coupled to the second device, and wherein the second device is further configured to generate a request for the second data, and wherein the second data is conveyed from the remote content server to the second device in response to the request.

35. A system for recreating data at a remote location in a television system comprising:
an operator configured to convey a plurality of edit lists and a broadcast signal; and
a plurality of receiving devices coupled to receive the edit lists and the broadcast signal;
wherein the edit lists identify programming material, and wherein each of the receiving devices are configured to process a received edit list and receive programming material identified by the processed edit list.

36. The system of claim 35, wherein the operator is configured to identify particular viewing audience members corresponding to each of the receiving devices which conform to a particular profile, and wherein the operator is configured to generate an edit list corresponding to that profile and convey that edit list to those particular viewing audience members.

37. The system of claim 35, wherein the operator is configured to generate a plurality of edit lists, each of which identify a different collection of programming material, and wherein the operator is configured to make the generated edit lists available for access by members of a viewing audience.

38. A method for recreating data in a television system comprising:
generating a message at a first location, wherein the message identifies a first data;
conveying the message to a remote database;
storing the message in the database;
searching the database;
recreating the first data at a second location in response to identifying and accessing the message.

39. The method of claim 38, wherein the first data, and wherein recreating the first data includes receiving the first data in response to a request.

40. The method of claim 39, wherein the first data is received from a third location.

41. The method of claim 40, wherein the first data is received via television broadcast signal.

42. The method of claim 38, wherein generating the message comprises a viewer tagging program material.

43. The method of claim 42, wherein the first data comprises two or more selected portions of the program material.
